(19) United States
(12) Patent Application Publication
(10) Pub. No.: US 2015/0066741 A1
(43) Pub. Date: Mar. 5, 2015

(54) METHOD AND SYSTEM FOR PAYMENT DISTRIBUTION FOR CONSIGNED ITEMS

(71) Applicant: John Duncan Wannamaker, La Crosse, WI (US)

(72) Inventor: John Duncan Wannamaker, La Crosse, WI (US)

(73) Assignee: INTUIT INC., Mountain View, CA (US)

(21) Appl. No.: 14/011,596

(22) Filed: Aug. 27, 2013

(51) Int. Cl. G06Q 40/00; G06Q 20/02

(52) U.S. Cl. CPC G06Q 40/00; G06Q 20/023
USPC 705/39

(57) ABSTRACT

A method for distributing payment for a consigned item includes receiving a notification of a purchase of the consigned item, identifying a consignor of the consigned item purchased, obtaining a sales fee agreement of the consigned item, calculating, using the sales fee agreement by a computer processor, a consignor fee from the purchase using the sales fee agreement, calculating, using the sales fee agreement by the computer processor, a consignee fee from the purchase, crediting a consignor financial account for the purchase with the consignor fee, and crediting a consignee financial account for the purchase with the consignee fee.

### BACKGROUND

In general, consignors give consignees possession of items to sell, while still retaining ownership of the items. When the item is purchased, the consignor and consignee split the sales price. Consignees usually keep track of the price and goods from the consignor in a consignment log, which is often kept separate from the consignee's other financial statements.

Continuing with the discussion, when the consignor's item is sold, the consignee marks the sale in the consignment log. On a regular basis, the consignee balances the consignee's books and determines whether the consignor's item was sold using the consignment log. If the consignor's item was sold, then the consignee calculates the amount that is owed to consignor and gives a check to the consignor for the amount.

### SUMMARY

In general, in one aspect, the invention relates to a method for distributing payment for a consigned item includes receiving a notification of a purchase of the consigned item, identifying a consignor of the consigned item purchased, obtaining a sales fee agreement of the consigned item, calculating, using the sales fee agreement by a computer processor, a consignor fee from the purchase using the sales fee agreement, calculating, using the sales fee agreement by the computer processor, a consignee fee from the purchase, crediting a consignor financial account for the purchase with the consignor fee, and crediting a consignee financial account for the purchase with the consignee fee.

In general, in one aspect, the invention relates to a system for distributing payment for a consigned item includes a processor, a payment application executing on the processor, and a consignment fee calculator operatively connected to the payment application executing on the processor. The payment application is configured to receive a notification of a purchase of the consigned item, identify a consignor of the consigned item purchased, obtain a sales fee agreement of the consigned item, credit a consignor financial account for the purchase with the consignor fee, and credit a consignee financial account for the purchase with the consignee fee. The consignment fee calculator is configured to calculate, using the sales fee agreement, a consignor fee from the purchase using the sales fee agreement, and calculate, using the sales fee agreement, a consignee fee from the purchase.

In general, in one aspect, the invention relates to a non-transitory computer-readable storage medium storing instructions for inventory management. The instructions includes functionality to receive a notification of a purchase of the consigned item, identify a consignor of the consigned item purchased, obtain a sales fee agreement of the consigned item, calculate, using the sales fee agreement by a computer processor, a consignor fee from the purchase using the sales fee agreement, calculate, using the sales fee agreement by the computer processor, a consignee fee from the purchase, credit a consignor financial account for the purchase with the consignor fee, and credit a consignee financial account for the purchase with the consignee fee.

Other aspects of the invention will be apparent from the following description and the appended claims.

### BRIEF DESCRIPTION OF DRAWINGS

FIG. 1 shows a schematic diagram of a system in accordance with one or more embodiments of the invention.

FIGS. 2-3 show flowcharts in accordance with one or more embodiments of the invention.

FIGS. 4A-4C show an example in accordance with one or more embodiments of the invention.

FIG. 5 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for payment distribution for sale of consigned items. Specifically, embodiments of the invention link a consigned item to a sales fee agreement between the consignor and consignee. Upon notification of the purchase of a consigned item, a payment application calculates and credits consignee and consignor accounts with payment according to the sales fee agreement. Thus, the payment application may provide for the consignor to receive payment without having to ask the consignee whether the consigned item sold.

As used herein, an entity (e.g., consignor, consignee, general consumer, non-profit organization) performs an action when an agent of the entity, a computer system for the entity, or individual or group related to the entity performs an action on behalf of the entity. Similarly, information is presented to the entity when information is presented to an agent of the entity, a computer system for the entity, or individual or group related to the entity performs an action on behalf of the entity.

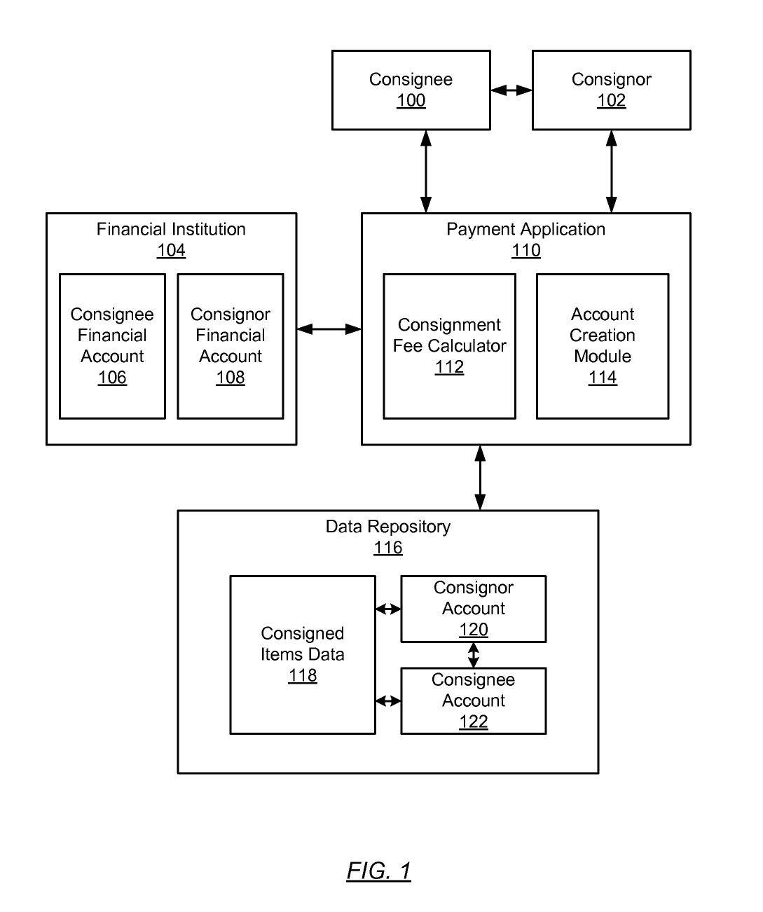

FIG. 1 shows a schematic diagram of a payment distribution system in accordance with one or more embodiments of the invention. In general, the payment distribution system manages the distribution of payment to a consignor (102) and consignee (100) when a consigned item is purchased.

A consignee (100), as used herein, is a business entity that has possession of and sells items on behalf of the consignor (102) of an item. Specifically, the consignee (100) may maintain a physical store at a geographic location, in which customers visit to purchase items. Furthermore, the consignee (100) may sell the consigned items to customers via a network site (e.g., Internet site, website).

For example, consignees (100), such as auction houses, consignment shops, pawn shops, and used car dealerships, retain physical possession of consigned items until the items are sold. A consigned car at a used car dealership, for example, is a part of the consignee's inventory until the car is sold, at which point the consigned car is removed from inventory and the sales fee agreement is executed.

A consignor (102), as used herein, is an entity that gives consignee (100) possession of the consigned item to sell even though the consignor (102) still retains ownership. The consignor (102) may consign a variety of items to consignee (100) (e.g., clothes, books, electronics, etc.). An example of a consignor (102) is a person who consigns a book to a used book store and expects payment only when the book is sold. The consignor (102) retains ownership of the book even though the consignee (100) has possession of the book.

A consigned item, as used herein, is a tangible item that the consignor (102) owns but is in the possession of the consignee (100). The consigned item may include a book, a clothing item, an electronic device, or any other physical item.

A sales fee agreement, as used herein, is a business contract between consignee (100) and consignor (102) that specifies the fee each party receives upon purchase of the consigned item. Further, the sales fee agreement is agreed to by both consignor (102) and consignee (100) prior to the consignment of the item. Specifically, the consignor fee is the amount received by the consignor for the purchase of the item. The consignee fee is the amount received by the consignee for the purchase of the item. The consignor fee and consignee fee may be specified using virtually any fee-defining mechanism. For example, the consignor fee may be specified in terms of percentage, absolute amount, or any other amount as a function of net revenue, gross revenue, gross revenue minus a predefined set of fees, or any other function. For example, if the purchase price of the consigned item is $100 and the consignor fee is 60%, the consignor (102) would receive $60 while the consignee (100) would receive $40 ($100-$60). The sales fee agreement may be an individual contract or a term in a consignment contract. For example, the sales fee agreement and/or consignment contract may include additional terms, such as handling partial or total loss of the item, sales price discount policy, maximum and/or minimum time for consignment, or other terms or combinations thereof.

As shown in FIG. 1, the payment distribution system includes a data repository (116), financial institution (104), and payment application (110). Each of these components is described below.

In one or more embodiments of the invention, a data repository (116) is any type of storage unit and/or device (e.g., a file system, database, collection of tables, or any other storage mechanism) for storing data. Specifically, the data repository (116) may include hardware and/or software. Further, the data repository (116) may include multiple different storage units and/or devices. The multiple different storage units and/or devices may or may not be of the same type or located at the same physical site.

In one or more embodiments of the invention, the data in the data repository (116) includes consigned items data (118), consignor accounts (120), and consignee accounts (122). Each of the types of data is discussed below.

Consigned items data (118) corresponds to administrative data describing a consigned item to be sold. The consigned items data (118) may include item name, item description, item category, quantity of the items, consignor identifier, item identifier, past sales history, current sales fee agreement, related sales fee agreements, and an expiration date of the consigned item.

The item name may include keywords that are related to the consigned item that distinguish the consigned item from other inventory items of different types. The item name may not include all keywords used in relation to the consigned item, but rather the most searched keywords. The item name may be a consignee-provided name or a pre-stored name provided by the vendor of the payment application. For example, the item name may be a manufacturer and model number of the consigned item.

In one or more embodiments of the invention, the item description may include a textual phrase describing the attributes of the item such as size, model number, weight, place of origin, manufacturer, and supplier of inventory item. Further, the description may include an image of the item, video of the item being used, and a link to a product webpage.

The item category is a product category that is defined by consignee. Specifically, the product category is the class of goods of the consigned item. For example, if the consignee is a department store, the product categories may be kid's clothing, women's clothing, men's clothing, jewelry, sandals, tennis shoes, and kid's shoes.

In one or more embodiments of the invention, the quantity of items of the consigned item is the number of units of the consigned item that the consignor is offering for consignment. In one or more embodiments of the invention, the quantity of items may not reflect the total number of units the consignor is consigning, but rather is the number of identical consigned items consigned by the consignor.

In one or more embodiments of the invention, the consignor identifier is a unique identifier that is used by the payment distribution system to distinguish consignor accounts from each other. The consignor identifier may include a string of numbers, letters, or a combination of both. Further, the unique consignor identifier may be assigned randomly by the payment distribution system.

In one or more embodiments of the invention, the item identifier is a unique identifier that is used by the data repository to distinguish consigned items within inventory. The item identifier may include a stock-keeping unit (SKU) identifier, a Universal Product Code (UPC) identifier, and international standard book number (ISBN) identifier. Further, the item identifier may be a string of letters, numbers, or a combination of both as assigned by the inventory management system. In one or more embodiments of the invention, the item identifier may be specific to the item as well as the consignor. For example, two identical dresses consigned by two different consignors may have two different item identifiers in order to uniquely identify a consignor's item.

In one or more embodiments of the invention, the consigned items data may also include past sales history of a given item. Specifically, the previous sales history may have statistics regarding the highest rate of sale of the item, which consignors had the highest quality product, and the time of year with the most sales.

In one or more embodiments of the invention, the current sales fee agreement is the agreement that the consignor and consignee decide upon when adding the new item to inventory. The current sales fee agreement may also include the expiration date for the agreement.

In one or more embodiments of the invention, the related sales fee agreements may include default sales fee agreements, alternate sales fee agreements, and past sales fee agreements, for a given item. The default sales fee agreement may be a predetermined agreement between consignor and consignee across all consigned items. Further, the default sales fee agreement may also be an agreement predetermined by the consignor for the given item. Along with the sales fee agreement associated with an item, the consignor may specify that the agreement is only valid for a certain amount of time and that an alternate agreement takes effect afterwards. For example, the consignor may specify that the sales fee agreement regarding a consigned scarf is only valid during the winter. The consignor may then specify an alternate sales fee agreement to take effect if the consigned scarf is still in inventory when spring approaches. In one more embodiments of the invention, the payment distribution system may use past sales fee agreements associated with the consigned item to formulate and recommend a sales fee agreement. The past sales fee agreements may be agreements made with the same or different consignors.

In one or more embodiments of the invention, the expiration date of item is the date when the item is no longer usable. The expiration date may include spoilage dates for perishable items such as chocolate, cake mix, and bread. In one or more embodiments of the invention, the expiration date of the item is related to the selection of an alternate sales fee agreement after a predetermined amount of time. Further, the expiration date may be used in conjunction with related sales fee agreements to formulate and recommend an agreement for a given consigned item.

Returning to the data repository (116), the consignor account (120) shown in FIG. 1 is a record about the consignor and the items the consignor is offering for consignment. The consignor account (120) includes contact information, bank account information, the consignor identifier, default sales fee agreement, security credentials, and a tracking tool.

In one or more embodiments of the invention, the contact information is the consignor's preferred method of communication and, optionally, alternative methods for communication. The contact information may include the consignor's name, phone number, e-mail address, and mailing address.

In one or more embodiments of the invention, the bank account information is consignor's preferred method of receiving payment. The bank account information may include the bank name, bank account number, and a method of payment transfer. For example, the consignor may specify the preferred method of payment is direct deposit into a checking account at a certain bank.

In one or more embodiments of the invention, the security credentials are identifiers that the consignor uses to log into the consignor account. The security credentials may include a password and a unique username associated with the consignor. For example, the consignor may log into the consignor account with the username “Consignor12” and password “SellStuff.” The security credentials may include security questions to assist with resetting the password for an account. Further, the security credentials may include a fingerprint scan or similar biometric scan.

In one or more embodiment of the invention, the tracking tool is a tool to calculate metrics relating to products consigned by a given consignor. The tracking tool may include statistics all products consigned by consignor, past sales fee agreements with the consignor, and rankings of a given consignor compared to other consignors.

Returning to the data repository (116), the consignee account (122) shown in FIG. 1 is a record about the consignor and the items the consignor has offered for consignment. The consignee account (122) includes contact information, bank account information, consignee identifier, consignor identifiers, security credentials, and a tracking tool.

In one or more embodiments of the invention, the contact information is the consignee's preferred method of communication and, optionally, alternative methods for communication. The contact information may include the consignee's name, phone number, e-mail address, and mailing address.

In one or more embodiments of the invention, the bank account information is consignee's preferred method of transferring money. The bank account information may include the bank name, bank account number, and a method of payment transfer. For example, the consignee may specify the preferred method of transferring money is via direct deposit.

In one or more embodiments of the invention, the consignee identifier is a unique identifier that is used by the payment distribution system to distinguish consignee accounts from each other. The consignee identifier may include a string of numbers, letters, or a combination of both. Further, the unique consignee identifier may be assigned randomly by the payment distribution system.

In one or more embodiments of the invention, the consignor identifier(s) may be one or more of the consignor identifiers of consignor accounts managed by the payment distribution system. The consignee account (122) relates records of current and past consignors to consignor identifiers, regardless of whether a sale of the consignor's item has been made in accordance with one or more embodiments of the invention.

In one or more embodiments of the invention, the security credentials are identifiers that the consignee uses to log into the consignee account. The security credentials may include a password and a unique username associated with the consignee. For example, the consignee may log into the consignee account with the username “Consignee14” and password “BuyAndSellStuff.” The security credentials may include security questions to assist with resetting the password for an account. Further, the security credentials may include a fingerprint scan or similar biometric scan.

In one or more embodiment of the invention, the tracking tool is a tool to calculate metrics relating to products sold by a given consignee. The tracking tool may include statistics on all products sold by consignee, past sales fee agreements with all consignors, and rankings among products and consignors.

As discussed above, the system includes a financial institution (104). The financial institution manages financial accounts. Specifically, the financial institution includes the consignor financial account (108) and consignee financial account (106). The financial accounts at the financial institution (104) may correspond to monetary accounts to facilitate the deposit and withdrawal of money from one party to another. The account information is used to route money obtained from the purchase of the consigned item to the consignee financial account (106) and consignor financial account (108). In one or more embodiments of the invention, one or more financial institutions (104) may be used to facilitate the transfer of money. Although FIG. 1 shows the consignor financial account (106) and the consignee financial account (104) at the same financial institution, the accounts may be at different financial institutions without departing from the scope of the claims.

The data repository (116) and financial institution (104) are connected to a payment application (110) in accordance with one or more embodiments of the invention. The payment application (110) is software that creates consignor and consignee accounts as well as calculates fees according to the sales fee agreement when adding a new consigned item to inventory. Further, the payment application (110) may modify the sales agreement based on the consignor's preferences and send the modified sales fee agreement to the consignee. The payment application may be executed on any computer processor with the necessary hardware requirements including mobile devices, tablets, desktops, and laptops. In one or more embodiments of the invention, the payment application (110) may be used on mobile devices and connected to the rest of the system remotely via a network connection such as the Internet and/or internal network.

The payment application (110) includes a consignment fee calculator (112) and an account creation module (114). Each component is described below.

The consignment fee calculator (112) includes functionality to perform a series of mathematical operations to calculate the payment amounts according to the sales fee agreement. The consignment fee calculator (112) is connected to the payment application and includes the functionality to calculate the consignor fee and consignee fee from final purchase price of consigned item and the sales fee agreement.

The account creation module (114) stores information regarding the new consignee and consignor accounts in the data repository (116). The account creation module (114) includes the functionality to create a consignor account for a consignor and a consignee account for a consignee. The account creation module (114) may include various user interface components for gathering information.

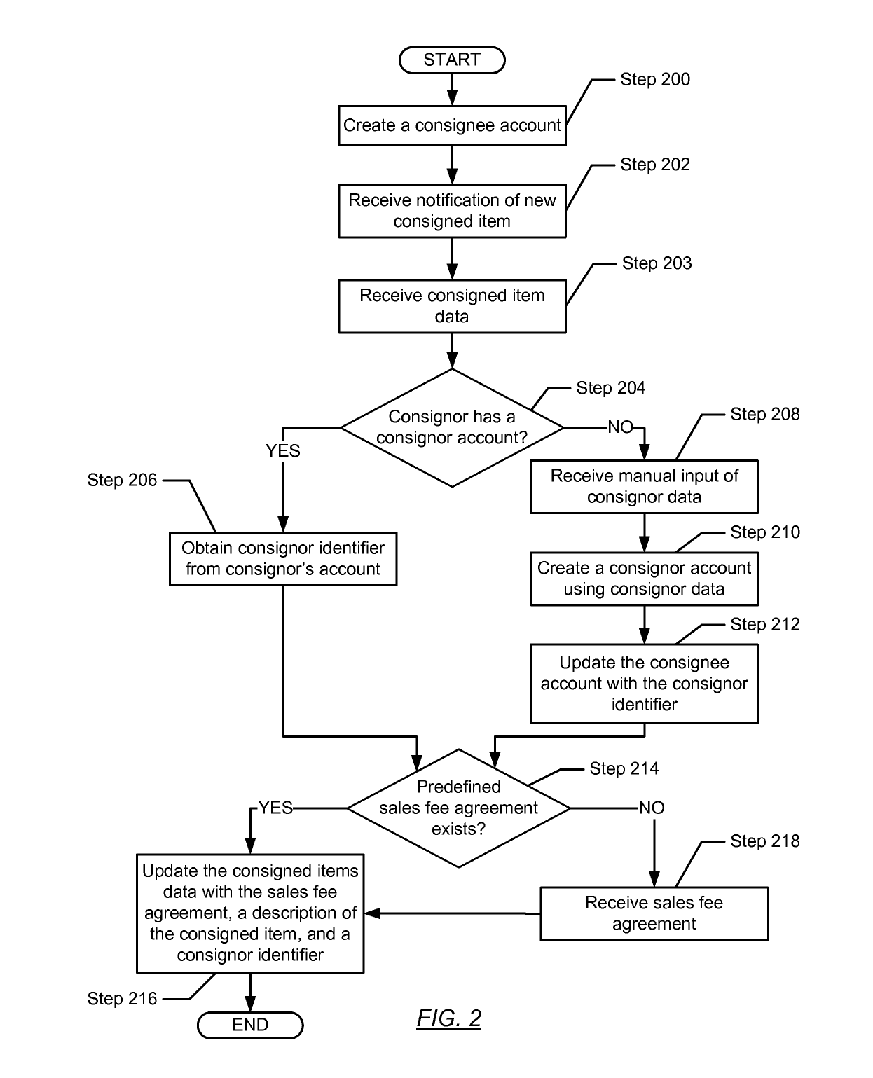

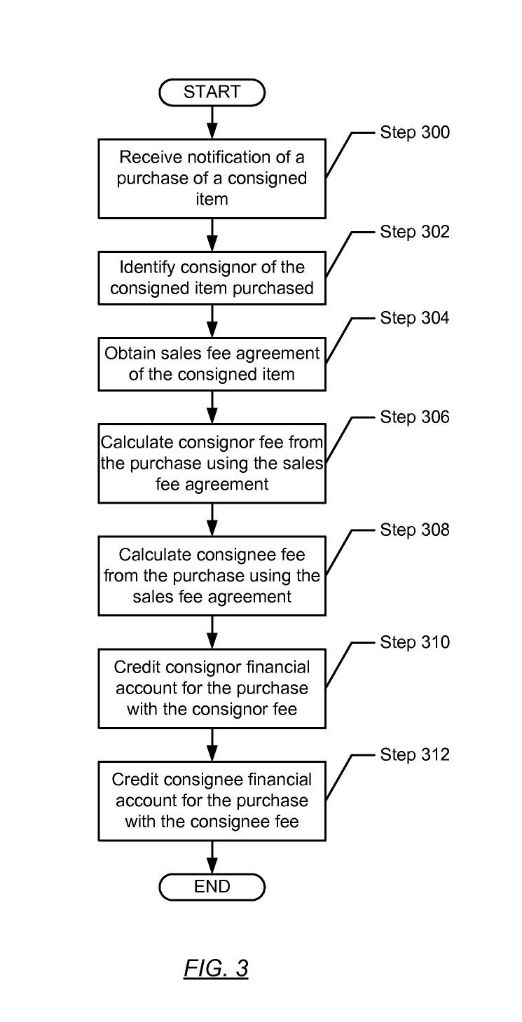

FIGS. 2-3 show flowcharts in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

FIG. 2 shows a flowchart for a consignor to consign an item to consignee using the payment distribution system in accordance with one or more embodiments of the invention. In Step 200, a consignee account is created in accordance with one or more embodiments of the invention. The creation of a consignee account may be triggered by the consignee selecting the “create a new account” or “first time user?” button. In one or more embodiments of the invention, creating an account may include obtaining contact information, generating a consignee identifier, prompting the consignee to input bank and contact information, obtaining security credentials from consignee, generating a tracking tool for the consignee, and storing the information, security credentials, and identifier in the data repository. In one or more embodiments of the invention, the new consignee account may be linked with a preexisting consignor account. For example, if a consignment bookstore sells consigned books and also consigns books to other consignees, the bookstore may have linked consignor and consignee accounts.

In one or more embodiments of the invention, the consignee may use a preexisting consignee account stored in the data repository instead of creating a new consignee account.

In Step 202, a notification of a new consigned item is received. The notification may be received when the “add new item” button on the payment application is selected. In one or more embodiments of the invention, the notification may also be triggered when predefined fields of consigned items data are input. For example, the notification may be triggered when the item's SKU identifier is scanned or when an image of the item is uploaded. Further, the notification may be triggered by verifying that both the consignor and the consignee have accounts in the data repository.

In Step 203, consigned item data for the consigned item is received. Using the payment application interface, the consignor and consignee may manually input the consigned item data fields such as item name, item description, item category, quantity of items, and expiration date of the consigned item. The consigned item data may be input through a variety of payment application interfaces including via mobile application, website, email, and text message.

For example, if the consignor is consigning a crate of oranges, the consignor and consignee set, via a mobile application, the item name to “California Clementines,” the item description to “none spoiled or damaged, grown in San Joaquin Valley,” the quantity of items to 2 pounds, and the expiration date to two weeks. In one or more embodiments of the invention, each field may be pre-populated with previously used values from prior transactions with the given consignor. Further, the fields may be pre-populated with values used in transactions between consignee and different consignors.

In Step 204, a determination is made whether an account for the consignor exists. In one or more embodiments of the invention, the consignor may be required to input security credentials to log on to the consignor account. The determination may then be made by checking whether the data repository has a consignor account that matches the submitted security credentials. The determination to create a consignor account may also be made if the consignor selects the “create new account” or “first time user?” button. Further, the creation of a consignor account may be triggered by the consignee sending the consignor a link via e-mail to create a new account. In one or more embodiments of the invention, the consignor may create multiple accounts depending on the category of items being sold. Further, in one or more embodiments of the invention, the consignor may have also have consignee accounts as well. For example, a business entity that consigns items may also act as a consignor by sub-consigning consigned items to another business.

In Step 206, if a determination is made that a consignor account exists, then the consignor identifier from consignor's account is obtained. The consignee account is then updated with the consignor identifier. In one or more embodiments of the invention, security credentials may be required to access the existing account information.

Returning to Step 204, if the consignor does not have an existing account, the payment application may receive manual input of consignor account data in Step 208. The new consignor account information may include banking information, security credentials, and contact information. In Step 210, a new consignor account is created in the data repository using the information submitted in Step 208. In one or more embodiments of the invention, creating a consignor account may include obtaining contact information, generating a consignor identifier, prompting the consignor to input bank and contact information, obtaining security credentials from consignor, generating a tracking tool for the consignor, storing the information, security credentials, and identifier in the data repository.

In Step 212, the consignee account is updated with the newly-created consignor identifier. In one or more embodiments of the invention, the consignee may need to input security credentials for the system to make changes to the account information.

Continuing with FIG. 2, after the consignor and consignee accounts are created, the payment distribution system has the account information. In Step 214, a determination is made whether a predefined sales fee agreement exists. The determination is made by checking the consignor account for a default agreement between consignor and consignee that applies to all consigned items or the given consigned item.

In Step 216, if a predefined sales fee agreement exists, then the consigned item data is updated to include the sales fee agreement, a description of the consigned item, and a consignor identifier. In one or more embodiments of the invention, the consignor and/or the consignee may be prompted as to whether the predefined sales fee agreement is to be used or if a new sales fee agreement should be created. The sales fee agreement of the consigned item may also be modified based on preferences set by the consignor and sent to the consignee, such as by email.

In one or more embodiments of the invention, the sales fee agreement may be modified if the consigned item is in possession of the consignor for a predefined amount of time. For example, if the sales fee agreement for a consigned book has an expiration date of one month, then a new sales fee agreement with a reduced consignor rate may replace the prior agreement after one month. In the example, a rare book is consigned to consignee with a consignor fee of 60%. After one month passes without the sale of the rare book, a new predefined sales agreement takes effect, lowering the consignor fee to 50%. In one or more embodiments of the invention, the consignee may purchase the consigned item after a predetermined amount of time has passed. In the example involving the rare book, the consignee purchases the book after one month passes at the same lowered consignor fee of 50%. In one or more embodiments of the invention, the consignor is notified of the passage of time without sale and reduced consignor fee via email.

In one or more embodiments of the invention, the sales fee agreement may be terminated completely once the expiration date of the item passes. In one or more embodiments of the invention, the expiration date of the sales fee agreement is calculated based on the expiration date of the consigned item. For example, if the sales agreement is for a crate of bananas that spoil within 2 weeks, the sales fee agreement may terminate after 2 weeks passes without the sale of the bananas. Further, after 2 weeks pass, the bananas may be removed from inventory and the tracking tool may record the passage of time without sale. In one or more embodiments of the invention, the consignor is notified of the sales fee agreement termination via email.

Continuing with Step 216, the sales fee agreement details for the consigned item may be aggregated with other previous sales fee agreement details in the consigned items data to provide metrics to the consignee via the tracking tool. The tracking tool may extract information from the consigned item data such as item expiration date and previous sales fee agreements to formulate a sales fee agreement. Further, the consignee may be presented with previous sales fee agreements used with other consignors for the same consigned item. The tracking tool may also recommend an expiration date for the sales fee agreement based on past sales fee agreements, item expiration date, and the time of year when the agreement is made.

Returning to Step 214, if a predefined sales agreement does not exist, then the consignor and consignee may manually input the sales fee agreement data into the payment distribution system to be stored in the data repository in Step 218.

FIG. 3 shows a flowchart for a payment distribution system receiving a notification of the purchase of a consigned item in accordance with one or more embodiments of the invention. Specifically, the payment distribution system credits payment amounts to consignor and consignee as set forth by the sales fee agreement.

In Step 300, the payment application receives notification of a purchase of a consigned item. Specifically, the notification of purchase of consigned item is sent based on a completion of payment from a point of sale device of the consignee.

In one or more embodiments of the invention, the point of sale device includes devices used for the sale of goods. Point of sale devices include functionality to process purchases, scan product codes for the identification of items, and perform other functions related to the sale of goods. For example, the point of sale device may include a card reader (e.g., credit/debit card reader), a bar code reader, a receipt printer, an inventory scanner (e.g., RFID, Bar Code, Quick Response (QR) codes/matrix barcodes, etc.), a pin pad, computer system(s), and other devices. In one or more embodiments of the invention, at least a portion of the components of the point of sale device may be located on a mobile device.

In one or more embodiments of the invention, the notification may be triggered by the completed transfer of payment from consumer to consignee when the consigned item is purchased. Further, the notification may be triggered when the consignee scans the item and the charge for the item is pending but has not posted. The notification may also be triggered when a predetermined amount of time has passed resulting in the consignee buying the consigned item from consignor. In one or more embodiments of the invention, if the expiration date of the consigned item passes and the sales fee agreement terminates, the notification may be triggered to alert the consignor that the sales fee agreement has terminated.

In Step 302, the payment distribution system identifies the consignor of a purchased consigned item. In one or more embodiments of the invention, the system may use the consigned item identifier to identify the item in the consigned items data and then obtain data pertaining the consignor and consignee from the corresponding consignor and consignee accounts. Further, once the consignor is identified, a message (e.g., email, short messaging system (SMS), or other types of messages) may be sent to the consignor comprising notification of the purchase of the consigned item. In one or more embodiments of the invention, the notification may also notify the consignor that the sales fee agreement expired.

In Step 304, the payment distribution system obtains the sales fee agreement of the consigned item from the consigned items data stored in the data repository. In one or more embodiments of the invention, the sales fee agreement may apply to multiple different consigned items.

In Step 306, the consignor fee from the purchase is calculated using the sales fee agreement. Specifically, a consignment fee calculator connected to the payment application calculates the consignor fee based on the sales fee agreement. For example, after the calculator obtains the sales fee agreement in the data repository associated with the consigned item, the calculator uses the consignor fee percentage, consignee fee percentage, and final purchase price, to apply in a formula used to split profits. By inserting both consignor and consignee values into the formula, the calculator determines the consignor fee.

In Step 308, the consignment fee calculator calculates the consignee fee using the sales fee agreement. In one or more embodiments of the invention, the calculator uses the sales fee agreement data and the final purchase price to calculate the consignee fee.

In Step 310, the payment distribution system connects with the financial institution and credit the consignor financial account with the consignor fee as calculated above. In one or more embodiments of the invention, the crediting of the consignor account may occur using direct deposit, check, or online money transfer.

In Step 312, the payment application connects with the financial institution and credit the consignee financial account with the consignee fee as calculated above. In one or more embodiments of the invention, the crediting of the consignee account may occur using direct deposit, check, or online money transfer. Following the example above, the payment application may credit the consignee account for $60 by direct deposit.

In one or more embodiments of the invention, the money may be routed directly from the purchaser's financial account to the consignor and consignee financial accounts. For example, the purchaser pays $60 for a dress, $40 of which goes to the consignor and $20 of which goes to the consignee as decided in the sales fee agreement. In the example, $40 is directly routed from the purchaser's financial account to the consignor's financial account. Similarly, $20 is routed from the purchaser's account to the consignee's financial account. The routing of the money may be performed by the payment application with or without the point of sale device. For example, the payment application may instruct a merchant financial institution that processes payment requests for the point of sale device to route the funds in accordance with the calculated amounts.

In one or more embodiments of the invention, the money may be routed to the consignee's financial account and then distributed to the consignor financial account. For example, the purchaser pays $100 for a coat, $80 of which goes to the consignor and $20 of which goes to the consignee as decided in the sales fee agreement. In the example, $100 is routed from the purchaser's financial account to the consignee's financial account. Then, $80 is transferred from the consignee's financial account to the consignor's financial account. The routing of the money may be performed by the payment application with or without the point of sale device. For example, the payment application may instruct the consignee's financial institution to transfer the consignor amount to the consignor's account.

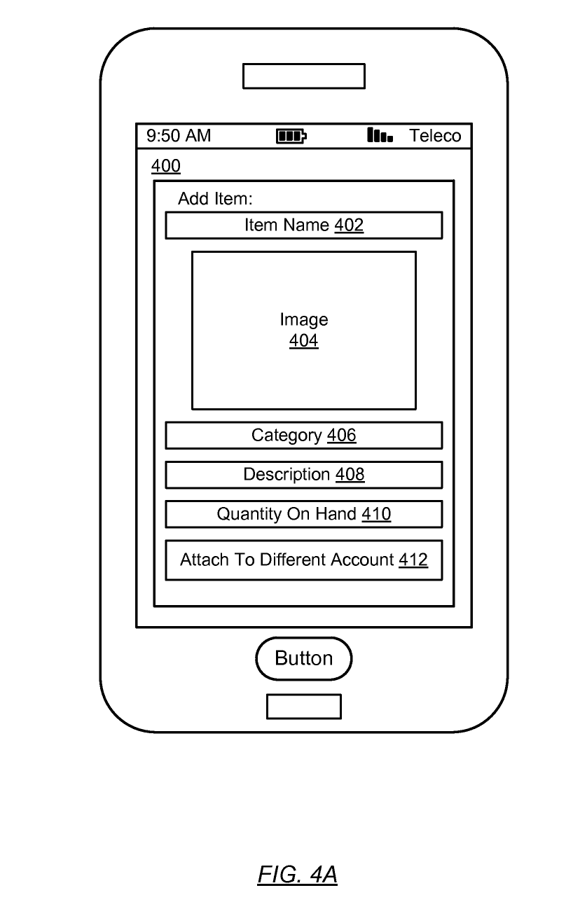

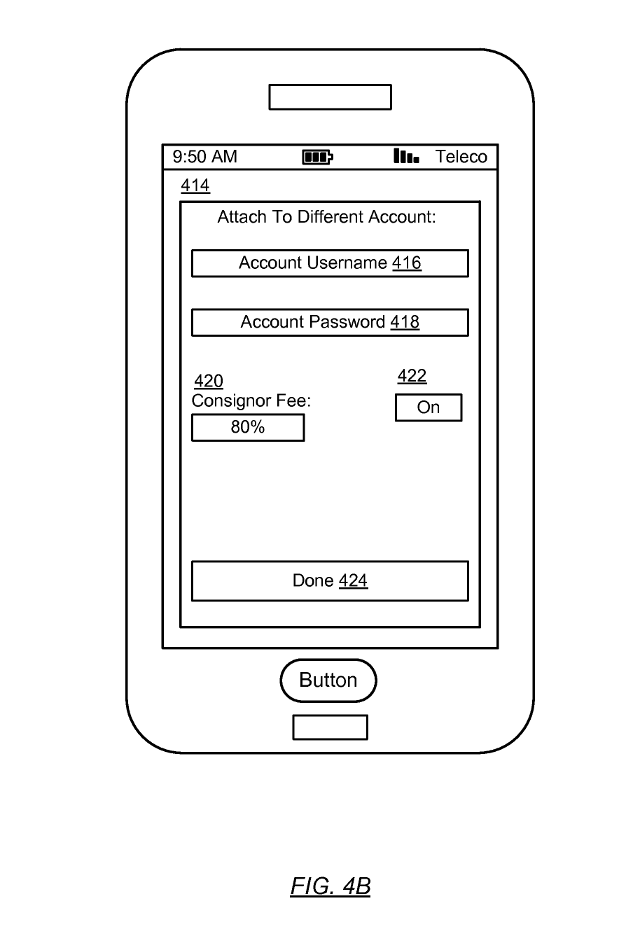

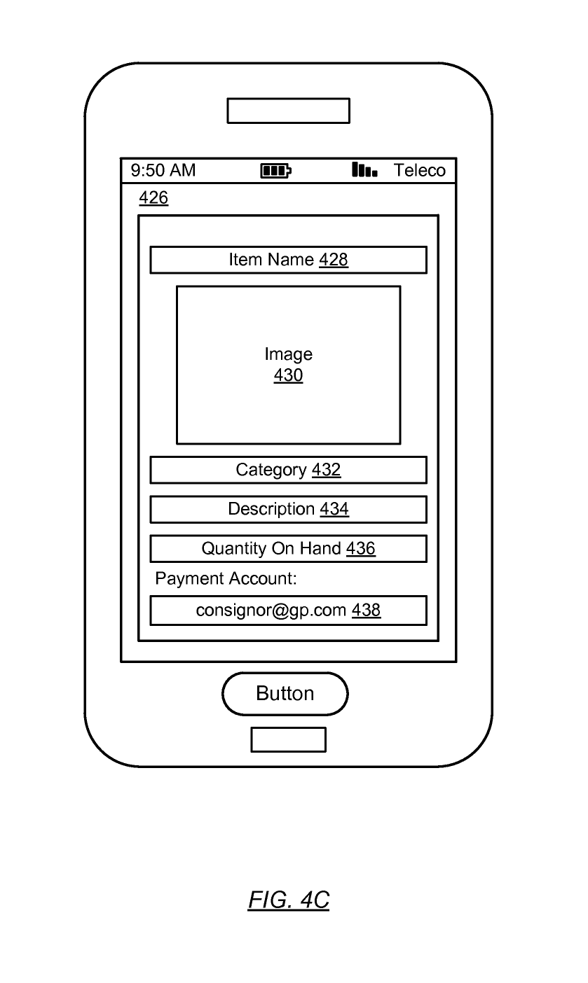

FIGS. 4A-4C show an example in accordance with one or more embodiments of the invention. The following example is for explanatory purposes only and is not intended to limit the scope of the invention. For the following example, consider the scenario in which the consignee is a clothing store owned by Janet. In the example, the clothing store is deemed to perform actions when Janet performs actions on behalf of the clothing store. Similarly, the clothing store is deemed to receive notifications when Janet receives notifications on behalf of the clothing store.

As shown in FIG. 4A, the clothing store uses a payment distribution system (400) to manage the sale of consigned items. For example, consider the scenario in which on July 20, Chrissy comes into the store to consign a dress to Janet. For this example, Chrissy is the consignor of the dress and Janet is the consignee of the dress. Janet and Chrissy, as a frequent users of the payment distribution system, both have consignee and consignor accounts, respectively. Janet first logs into the payment application on her mobile device using her consignee account information and selects the option in the application to add a new consigned item.

The payment application (400) allows Janet and Chrissy to input a new consigned item to sell. Chrissy and Janet input the details regarding the dress including item name (402), pictures of the item (404), category (406), description (408), and the quantity on hand of the dress (410). Janet names the dress as “Chanel Blue Floral Dress,” places the dress under the category of clothing, describes the dress as “Size 4 Chanel blue floral dress with blue lace trim,” and adds that the quantity of dress is one. Because the dress is being consigned to Janet by Chrissy, Janet selects the Attach to Different Account option (412) on the application. The selection of the Attach to Different Account option triggers a notification to the payment distribution system to check if Chrissy has a preexisting consignor account.

As shown in FIG. 4B, Chrissy may input the consignor account information. Here, Chrissy logs in with her preexisting consignor account with her security credentials, namely her account username (416) and account password (418). She then turns the consignor fee feature on (422).

Because Janet and Chrissy have done business together before, their predetermined sales fee agreement stands at a consignor fee of 60%, regardless of the type of consigned item. The payment application pre-populates the consignor fee box (420) with a fee of 60% accordingly.

After discussing that the dress is designer label, Janet and Chrissy decide to change the predetermined sales fee agreement and instead set the consignor fee at 80% and the consignee fee at 20%. Janet inputs the fee of 80% into the consignor fee box (420) and then selects the “done” option (424).

As shown in FIG. 4C, Chrissy and Janet view the details of the consigned item including the item name (428), item description (434), and quantity on hand (436). Chrissy can also check that the payment account box is correctly populated with her email address (438), as is the case here.

On August 4, a customer comes into the store and decides to buy the dress for $100. Once the customer slides her credit card through a credit card reader to pay for the dress, the credit card reader, a point of sale device, sends a notification to the payment distribution system. Minutes later, Chrissy receives an email notifying her of the purchase of the Chanel dress for $100.

As a result, the notification of the purchase of the dress also initiates the fee payment to both Chrissy and Janet even though the charge from the customer is still pending. Based on Janet's configuration of the payment distribution system, the method of payment transfer is set to be directly transferred from the purchaser's account to the consignor and consignee financial accounts. Chrissy receives $80 into her financial account routed from the purchaser's account and Janet receives $20 into her financial account routed from the purchaser's account.

Prior to Janet's use of the payment distribution system, Chrissy checked with Janet on a weekly basis to find out whether a consigned item was sold. Further, Chrissy received actual payment at the end of the month when Janet balanced the store's books regardless of when the item was sold within the month. Accordingly, with Janet's use of the payment distribution system, Chrissy no longer has to check with Janet to determine whether a consigned item was sold. Instead, Chrissy received an email notifying her of the purchase and the purchase price. Further, Chrissy is able to receive the consignor fee upon the purchase of consigned items and no longer has to wait for Janet to balance the store's books at the end of the month to receive payment. In this example, Chrissy received the consignor fee on the same day that the dress was purchased.

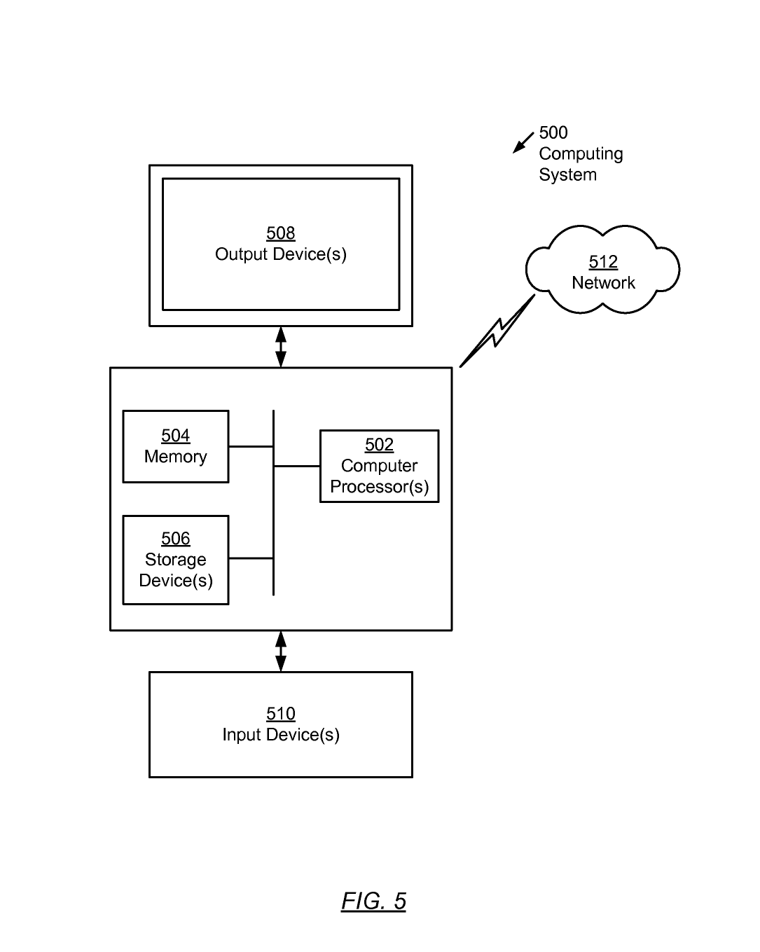

Embodiments of the invention may be implemented on virtually any type of computing system regardless of the platform being used. For example, the computing system (500) may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 5, the computing system (500) may include one or more computer processor(s) (502), associated memory (504) (e.g., random access memory (RAM), cache memory, flash memory, etc.), one or more storage device(s) (506) (e.g., a hard disk, an optical drive such as a compact disk (CD) drive or digital versatile disk (DVD) drive, a flash memory stick, etc.), and numerous other elements and functionalities. The computer processor(s) (502) may be an integrated circuit for processing instructions. For example, the computer processor(s) may be one or more cores, or micro-cores of a processor. The computing system (500) may also include one or more input device(s) (510), such as a touchscreen, keyboard, mouse, microphone, touchpad, electronic pen, or any other type of input device. Further, the computing system (500) may include one or more output device(s) (508), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (500) may be connected to a network (512) (e.g., a local area network (LAN), a wide area network (WAN) such as the Internet, mobile network, or any other type of network) via a network interface connection (not shown). The input and output device(s) may be locally or remotely (e.g., via the network (512)) connected to the computer processor(s) (502), memory (504), and storage device(s) (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (500) may be located at a remote location and connected to the other elements over a network (512). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for distributing payment for a consigned item comprising:
receiving a notification of a purchase of the consigned item, wherein the notification of the purchase is sent based on a completion of payment from a device at a physical retail store;
identifying a consignor of the consigned item purchased;
obtaining a sales fee agreement of the consigned item;
calculating, using the sales fee agreement and by a computer processor, a consignor fee from the purchase using the sales fee agreement;
calculating, using the sales fee agreement and by the computer processor, a consignee fee from the purchase;
crediting a consignor financial account for the purchase with the consignor fee; and
crediting a consignee financial account for the purchase with the consignee fee.

2. The method of claim 1, wherein the device is a point of sale device of a consignee.

3. The method of claim 1, wherein the notification of the purchase notifies the consignor and a consignee that a predefined amount of time has passed and that the consignee has bought the consigned item.

4. The method of claim 1, further comprising:
modifying the sales fee agreement of the consigned item based on preferences set by the consignor; and
sending the modified sales agreement of the consigned item to a consignee.

5. The method of claim 4, wherein the sales fee agreement is modified based on the time the consigned item has been in the possession of the consignee.

6. The method of claim 2, wherein the point of sale device of the consignee is a mobile device.

7. The method of claim 1, further comprising:
sending an email message to the consignor comprising the notification of purchase of the consigned item.

8. The method of claim 1, further comprising:
identifying the consignor from a plurality of consignors corresponding to a plurality of consigned items; and
matching the purchase of the consigned item to the consignor from the plurality of consignors.

9. The method of claim 1, wherein the consignor fee comprises a percentage of an amount of the purchase of the consigned item and the consignee fee comprises a difference of the consignor fee and the amount of the purchase of the consigned item.

10. A system for distributing payment for a consigned item, comprising:
a processor;
a payment application executing on the processor and configured to:
receive a notification of a purchase of the consigned item, wherein the notification of the purchase is sent based on a completion of payment from a device at a physical retail store,
identify a consignor of the consigned item purchased,
obtain a sales fee agreement of the consigned item,
credit a consignor financial account for the purchase with the consignor fee, and
credit a consignee financial account for the purchase with the consignee fee; and
a consignment fee calculator operatively connected to the payment application executing on the processor and configured to:
calculate, using the sales fee agreement, a consignor fee from the purchase, and
calculate, using the sales fee agreement, a consignee fee from the purchase.

11. The system of claim 10, further comprising:
an account creation module operatively connected to the payment application executing on the processor and configured to:
create an consignor account for the consignor; and
create a consignee account for a consignee.

12. The system of claim 10, further comprising:
a financial institution comprising a plurality of financial accounts further comprising the consignor financial account and the consignee financial account.

13. The system of claim 10, further comprising:
a data repository executing on the processor and configured to:
store a plurality of consigned item data;
store the consignor financial account; and
store the consignee financial account.

14. A non-transitory computer-readable storage medium for distributing payment for a consigned item, comprising instructions for:
receiving a notification of a purchase of the consigned item, wherein the notification of the purchase is sent based on a completion of payment from a device at a physical retail store;
identifying a consignor of the consigned item purchased;
obtaining a sales fee agreement of the consigned item;
calculating, using the sales fee agreement and by a computer processor, a consignor fee from the purchase;
calculating, using the sales fee agreement and by the computer processor, a consignee fee from the purchase;
crediting a consignor financial account for the purchase with the consignor fee; and
crediting a consignee financial account for the purchase with the consignee fee.

15. The non-transitory computer-readable storage medium of claim 14, wherein the device is a point of sale device of a consignee.

16. The non-transitory computer-readable storage medium of claim 14, further comprising instructions for:
modifying the sales fee agreement of the consigned item based on preferences set by the consignor to obtain a modified sales fee agreement of the consigned item; and
sending the modified sales agreement of the consigned item to a consignee.

17. The non-transitory computer-readable storage medium of claim 15, wherein the point of sale device of the consignee is a mobile device.

18. The non-transitory computer-readable storage medium of claim 14, further comprising instructions for:
sending an email message to the consignor comprising the notification of purchase of the consigned item.

19. The non-transitory computer-readable storage medium of claim 14, further comprising instructions for:
identifying the consignor from a plurality of consignors corresponding to a plurality of consigned items; and
matching the purchase of the consigned item to the consignor from the plurality of consignors.

20. The non-transitory computer-readable storage medium of claim 14, wherein the consignor fee comprises a percentage of an amount of the purchase of the consigned item, and wherein the consignee fee comprises a difference of the consignor fee and the amount of the purchase of the consigned item.
